(19) United States
(12) Patent Application Publication
(10) Pub. No.: US 2012/0163163 A1
(43) Pub. Date: Jun. 28, 2012

(54) APPARATUS AND METHOD FOR PROTECTION SWITCHING OF MULTIPLE PROTECTION GROUP

(75) Inventors: Dae-Ub KIM, Daejeon-si (KR); Sang-Min LEE, Daejeon-si (KR); Jeong-Dong RYOO, Daejeon-si (KR)

(73) Assignee: ELECTRONICS AND TELECOMMUNICATIONS RESEARCH INSTITUTE, Daejeon-si (KR)

(21) Appl. No.: 13/334,091

(22) Filed: Dec. 22, 2011

(30) Foreign Application Priority Data
Dec. 23, 2010 (KR) 10-2010-0133822

(51) Int. Cl. H04L 12/26

(52) U.S. Cl. 370/218

(57) ABSTRACT

There is provided a protection switching apparatus including: a path management unit to establish a plurality of connection paths for transmitting/receiving packets, and a plurality of protection paths that are able to substitute for the plurality of connection paths, respectively, and to create a protection group including the connection paths and the protection paths; a protection group controller to determine whether failure has occurred on the connection paths, based on path state information for each path included in the protection group, the path state information stored in the protection group table storage, and to issue an instruction for protection switching, according to the result of the determination; and a protection switching unit to perform protection switching of a path in which failure has occurred to a protection path corresponding to the path in which failure has occurred, according to the instruction for protection switching.

### CROSS-REFERENCE TO RELATED APPLICATION

This application claims the benefit under 35 U.S.C. §119(a) of a Korean Patent Application No. 10-2010-0133822, filed on Dec. 23, 2010, the entire disclosure of which is incorporated herein by reference for all purposes.

### BACKGROUND

1. Field

The following description relates to a packet network or a packet transport network, and more particularly, to an apparatus and method for protection switching of a multiple protection group, in which when failure has occurred on a path for receiving and transmitting packets, quick protection switching to a protection path is performed.

2. Description of the Related Art

Along with increase of Internet users, traffic of communication networks is increasing exponentially, and users are requiring various services, such as high-speed data services, e-commerce, telemedicine, virtual education, real-time multimedia services, etc.

Accordingly, in order to establish a stable communication network to provide users with seamless services and also to optimize network efficiency, a management technique for avoiding failure or performance deterioration of network is needed. Such a management technique is greatly classified into restoration and protection switching. Restoration is a method of restoring service interruption caused by occurrence of failure to an original service state using an available path and capacity of a network. Protection switching establishes extra paths and bandwidths between nodes to quickly restore any node where failure occurs.

Meanwhile, protection switching on a packet transport network establishes virtual connection paths between management points, and classifies the connection paths into operating paths and protection paths to establish protection groups. When failure occurs in a connection path belonging to a protection group, a management point recognizes occurrence of failure on the connection path and protection-switches the connection path to a protection path established in the protection group.

However, in conventional protection switching, when a plurality of protection groups exist in a single management point, the protection groups individually manage the state and switching of connection paths, and accordingly a network device corresponding to the management point has to repeatedly perform protection switching several times. Accordingly, the conventional protection switching consumes a long time for protection switching to a protection path upon occurrence of failure on any connection path belonging to a protection group.

### SUMMARY

The following description relates to a technique of quickly performing, when failure has occurred on a path belonging to a protection group in a packet transport network, protection switching to a protection path.

The following description also relates to a technique for quick protection switching between a plurality of paths having the same source and destination.

In one aspect, there is provided a protection switching apparatus for protection switching of a multiple protection group in a packet transport network, including: a path management unit to establish a plurality of connection paths for transmitting/receiving packets, and a plurality of protection paths that is able to substitute for the plurality of connection paths, respectively, and to create a protection group including the connection paths and the protection paths; a protection group controller to determine whether failure has occurred on the connection paths, based on path state information for each path included in the protection group, the path state information stored in the protection group table storage, and to issue an instruction for protection switching, according to the result of the determination; and a protection switching unit to perform protection switching of a path in which failure has occurred to a protection path corresponding to the path in which failure has occurred, according to the instruction for protection switching, thus transmitting/receiving the packets to/from a switched protection path.

The path management unit may include: a group creator to establish the protection paths that are able to substitute for the connection paths in correspondence to the connection paths, and to create the protection group including the connection paths and the protection paths; a multiple protection group creator to create the multiple protection group including the connection paths and the protection paths, wherein the connection paths are paths having the same source and destination among the connection paths included in the protection group, and the protection paths are able to substitute for the connection paths having the same source and destination in correspondence to the connection paths; an identification information creator to create identification information of the protection group, identification information of the connection paths included in the protection group, and identification information of the multiple protection group, wherein the protection group table storage stores the individual pieces of identification information created by the identification information creator, and path state information including the individual pieces of identification information.

The protection switching apparatus may further include: a path state management unit to determine whether or not failure has occurred on the paths included in the protection group and/or check operating states of the paths, thus updating path state information of the protection group stored in the protection group table storage.

Therefore, a multiple protection group including a plurality of connection paths and a plurality of protection paths corresponding to the connection paths may be created, wherein the connection paths are ones having the same source and destination among a plurality of connection paths belonging to a protection group, and the protection paths are alternate paths that can substitute for ones in which failure has occurred among the connection paths.

The protection group controller may include: a failure path checking unit to check whether failure has occurred on any one of the paths included in the protection group, according to the path state information updated by the path state management unit, and to inform, when failure has occurred on any one of the paths, the path state management unit of the fact that failure has occurred on the path in which failure has occurred, in order to update the path state information; a multiple protection group checking unit to check, when the path in which failure has occurred is protection switched to a protection path corresponding to the path in which failure has occurred, whether the path in which failure has occurred includes the identification information of the multiple protection group, based on path state information of the path in which failure has occurred; and a protection switching processor to instruct the protection switching unit to perform protection switching of the path in which failure has occurred or the multiple protection group, according to the result of the checking by the multiple protection group checking unit.

The protection switching unit may perform protection switching to a protection path corresponding to the path in which failure has occurred, according to an instruction for protection switching of the path in which failure has occurred.

The protection switching unit may determine whether the path in which failure has occurred is included in the multiple protection group, according to an instruction for protection switching of the multiple protection group, and protection-switches, if the path in which failure has occurred is included in the multiple protection group, the path in which failure has occurred and paths having the same source and destination as those of the path in which failure has occurred, to protection paths that are able to substitute for the path in which failure has occurred and the paths having the same source and destination.

Therefore, it is determined whether a path in which failure has occurred is included in a multiple protection group, and if the path is included in a multiple protection group, paths having the same source and destination as those of the path are at the same time protection switched to protection paths that can substitute for the corresponding paths.

When the same multiple protection group as a multiple protection group first checked by the multiple protection group checking unit is checked in a predetermined time period, the protection switching processor may instruct the protection switching unit not to perform protection switching of the same multiple protection group.

Accordingly, when failure occurs in a path included in a multiple protection group subject to protection switching in a predetermined time period, no protection switching is performed, thereby avoiding protection switching to the path in which failure has occurred.

In the case where a plurality of paths for transmitting/receiving packets are established in a packet transport network, and some of the paths have the same source and destination, when failure has occurred on one of the paths having the same source and destination, the paths having the same source and destination are all protection switched to protection paths that can substitute for the corresponding paths, thereby reducing a time consumed for protection switching.

Other features and aspects will be apparent from the following detailed description, the drawings, and the claims.

### BRIEF DESCRIPTION OF THE DRAWINGS

FIG. 1 is a diagram illustrating an example of a protection switching apparatus for protection switching of a multiple protection group.

FIG. 2 is a flowchart illustrating an example of a path establishing method which is performed in the protection switching apparatus.

FIG. 3 is a flowchart illustrating an example of a method for protection switching of a protection group including a multiple protection group, which is performed in the protection switching apparatus.

Throughout the drawings and the detailed description, unless otherwise described, the same drawing reference numerals will be understood to refer to the same elements, features, and structures. The relative size and depiction of these elements may be exaggerated for clarity, is illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

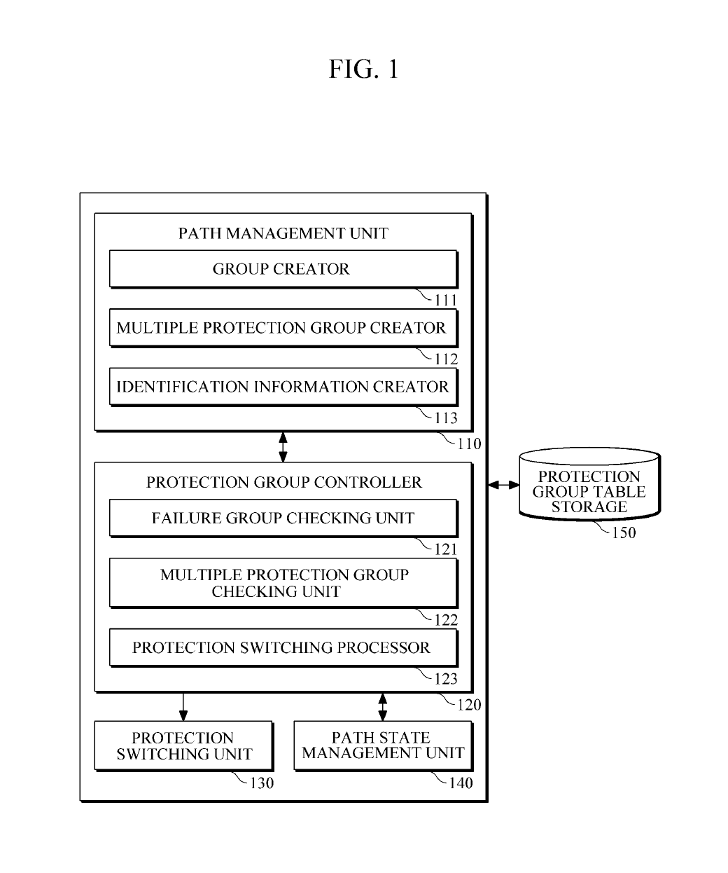

FIG. 1 is a diagram illustrating an example of a protection switching apparatus for protection switching of a multiple protection group.

Referring to FIG. 1, the protection switching apparatus includes a path management unit 110, a protection group controller 120, a protection switching unit 130, and a path state management unit 140.

The path management unit 110 establishes a plurality of connection paths for receiving and transmitting packets, and a plurality of protection paths that correspond to the connection paths and can substitute for the connection paths, and also the path management unit 110 creates a protection group including the connection paths and protection paths. Also, the path management unit 110 creates a multiple protection group, wherein the multiple protection group includes ones having the same source and destination among the connection paths included in the protection group, and a plurality of protection paths that can substitute for the connection paths having the same source and destination in correspondence to the connection paths. The multiple protection group may be included in the protection group.

The path management unit 110 includes a group creator 111, a multiple protection group creator 112, and an identification information creator 113. The group creator 111 establishes a plurality of connection paths and a plurality of protection paths in a packet transport network to create a protection group including the connection paths and the protection paths, wherein the protection paths are alternate paths that can substrate for the connection paths in correspondence to the connection paths. Here, the connection paths are paths for transmitting and receiving packets, and the protection paths are alternate paths for transmitting and receiving, when failure has occurred in one of the connection paths, the corresponding packets through protection switching.

The multiple protection group creator 112 creates a multiple protection group having a plurality of connection paths and a plurality of protection paths, wherein the connection paths are ones having the same source and destination among the connection paths established by the group creator 111, and the protection paths are alternate paths that can substrate for the connection paths having the same source and destination in correspondence to the connection paths. Accordingly, the protection group includes connection paths and protection paths, which are established by the group creator 111, wherein the protection paths can substitute for the connection paths in correspondence to the connection paths, and also the protection group includes a multiple protection group including ones having the same source and destination among the connection paths included in the protection group, and protection paths that can substitute for the connection paths having the same source and destination in correspondence to the connection paths.

The identification information creator 113 creates identification information of the connection paths established by the group creator 111, identification information of the protection group including the connection paths and the protection paths, and identification information of the multiple protection group. The identification information of the connection paths, the identification information of the protection group, and the identification information of the multiple protection group are stored in a protection group table storage 150. Also, the protection group table storage 150 stores path state information including the individual pieces of identification information. The path state information includes information about whether the states of operating paths and protection paths included in the protection group are in a normal state or in a failure state.

The path state information is updated by the path state management unit 140 and updated in the protection group table storage 150. That is, the path state management unit 140 determines whether each path included in the protection group is in a normal state, in real time, thus collecting path state information according to the result of the determination. Then, the path state management unit 140 updates previously stored path state information to the collected path state information.

The protection group controller 120 determines whether failure has occurred in the connection paths and protection paths included in the protection group, based on the path state information stored in the protection group table storage 150, thus instructing protection switching to be performed according to the result of the determination. The protection group controller 120 includes a failure group checking unit 121, a multiple protection group checking unit 122, and a protection switching processor 123.

The failure path checking unit 121 checks whether there is a path in which failure has occurred, based on the path state information updated by the path state management unit 140 and stored in the protection group table storage 150, and informs, when there is a path in which failure has occurred, the path state management unit 140 of the path so that the path state management unit 140 can update the path state information. As described above, the path state information includes identification information of paths and information about whether each path is in a normal state or in a failure state. Accordingly, the failure path checking unit 121 may check in which path failure has occurred, based on the path state information.

When a path in which failure has occurred is switched to a protection path by the path state management unit 140, the multiple protection group checking unit 122 checks whether there is identification information of a multiple protection group, based on path state information of the path in which failure has occurred, thus determining whether the path in which failure has occurred is included in the multiple protection group. If the path in which failure has occurred is included in the multiple protection group, path state information of the path includes identification information of the path, identification information of a protection group including the path, and identification information of a multiple protection group including the path. Accordingly, the multiple protection group checking unit 122 may determine whether or not identification information of a multiple protection group is included in the path state information of the path in which failure has occurred, thereby determining whether the path is included in a multiple protection group.

The protection switching processor 123 requests a protection switching unit 130 to perform protection switching on the path in which failure has occurred or on the multiple protection group. That is, if the multiple protection group checking unit 122 checks that no identification information of a multiple protection group is included in the path state information of the path in which failure has occurred, the protection switching processor 123 requests the protection switching unit 130 to perform protection switching to a protection path included in the corresponding path state information. Accordingly, the protection switching unit 130 performs protection switching to the protection path based on the identification information of the path in which failure has occurred.

Meanwhile, if the multiple protection group checking unit 122 checks that identification information of a multiple protection group is included in the path state information of the path in which failure has occurred, the protection switching processor 123 requests the protection switching unit 130 to perform protection switching of the corresponding multiple protection group. Accordingly, the protection switching unit 130 protection-switches the path in which failure has occurred and paths having the same source and destination as those of the path in which failure has occurred, to protection paths that can substitute for the paths, based on the identification information of the multiple protection group. For example, when failure has occurred in one of a plurality of connection paths included in the multiple protection group, the protection switching unit 130 performs protection switching to protection paths that can substitute for the individual connection paths included in the multiple protection group.

As such, according to the current example, by including paths having the same source and destination and protection paths that can substitute for the corresponding paths in the same multiple protection group, and protection-switching, when failure has occurred in one of the paths included in the multiple protection group, the corresponding path and paths having the same source and destination as those of the path at the same time to the corresponding protection paths, quick protection-switching is possible.

Meanwhile, when the multiple protection group checking unit 122 checks the same multiple protection group as a first checked multiple protection group in a predetermined time period, the protection switching processor 123 requests the protection switching unit 130 to perform protection switching on the first checked multiple protection group. That is, connection paths included in a multiple protection group have the same source and destination. Accordingly, when failure occurs in one of connection paths included in a multiple protection group, the remaining connection paths included in the multiple protection group also will be subject to failure at time intervals. As a result, the multiple protection group checking unit 122 checks that failure has occurred continuously at time intervals in the same multiple protection group. In this case, the protection switching processor 123 may again perform protection switching on the multiple protection group already subjected to protection switching, according to the checked result by the multiple protection group checking unit 122, thus transmitting/receiving packets to/from a path in which failure has occurred. Accordingly, the protection switching processor 123 performs protection switching only on a first checked multiple protection group although the same multiple protection group is checked several times in a predetermined time period.

So far, the components of the protection switching apparatus for protection switching of a multiple protection group have been described in detail. Now, a method in which the protection switching apparatus establishes a path for transmitting/receiving packets in a packet transport network will be described.

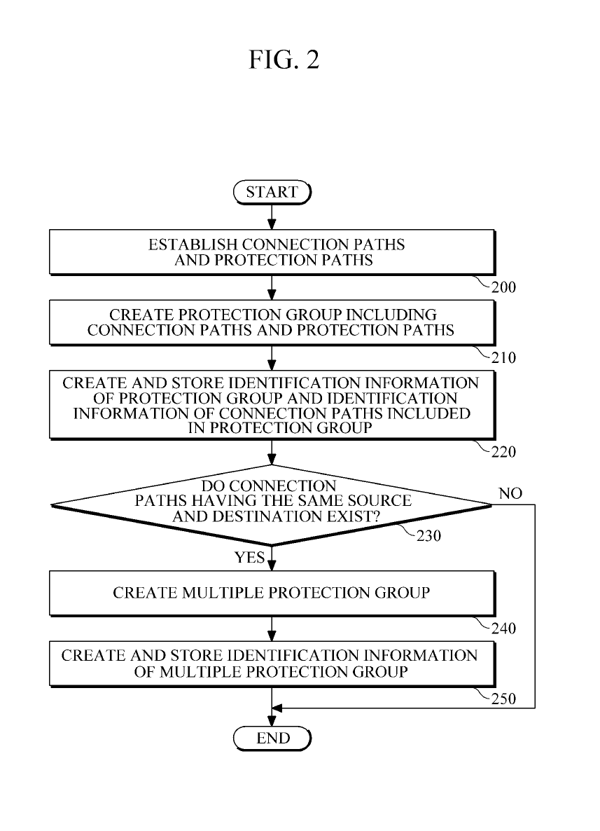

FIG. 2 is a flowchart illustrating an example of a path establishing method which is performed in the protection switching apparatus.

Referring to FIG. 2, the protection switching apparatus establishes at least one connection path for transmitting/receiving packets in a packet transport network, and establishes a protection path that can substitute for the connection path when failure has occurred on the connection path (200). Then, the protection switching apparatus creates a protection group including the connection path and protection path (210). Thereafter, the protection switching apparatus creates identification information of the protection group, identification information of the connection path included in the protection group, and identification information of a multiple protection group, and stores them in a protection group table storage (220). The protection group table storage stores identification information of protection groups and identification information of connection paths and protection paths included in each protection group, which are created by the protection switching apparatus, and path state information indicating the operating states of the individual paths. The path state information is information about whether or not packet transmission/reception on each path is in a normal state, and may include identification information of the corresponding path.

Meanwhile, the protection switching apparatus checks whether there are ones having the same source and destination among connection paths included in the protection group (230). If there are connection paths having the same source and destination, the protection switching apparatus creates a multiple protection group including the connection paths having the same source and destination and protection paths that can substitute for the connection paths (240). Then, the protection switching apparatus creates identification information of the multiple protection group, and stores the identification information of the multiple protection group in the protection group table storage (250).

As such, the protection switching apparatus may create a multiple protection group that includes ones having the same source and destination among a plurality of connection paths established in a packet transport network, and protection paths that can substitute for the connection paths having the same source and destination, and may perform, when failure has occurred in one of the paths included in the multiple protection group, protection switching on all the paths included in the multiple protection group at the same time, according to the following method.

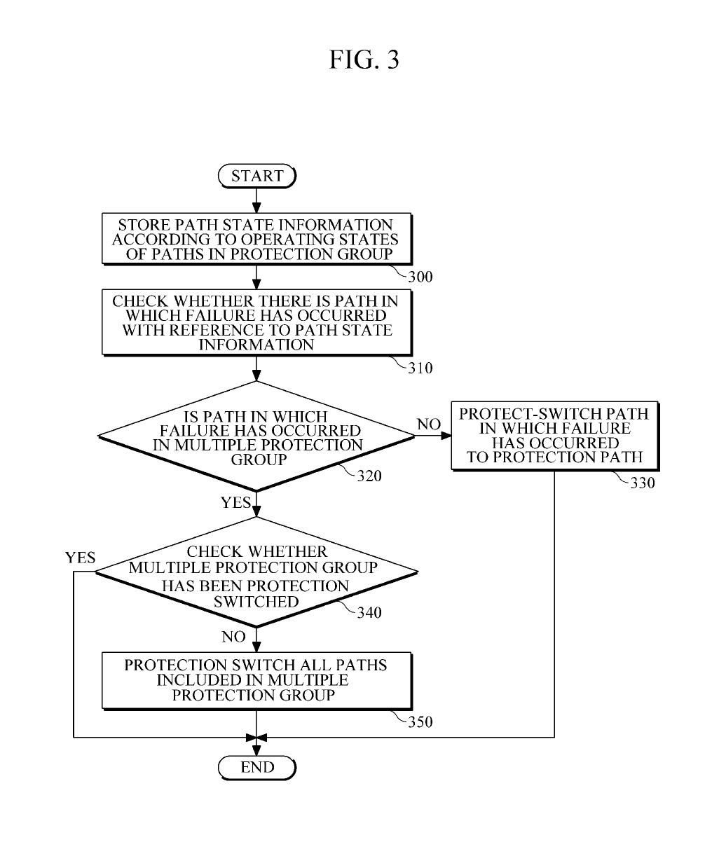

FIG. 3 is a flowchart illustrating an example of a method in which the protection switching apparatus performs protection switching on a protection group including a multiple protection group.

Referring to FIG. 3, the protection switching apparatus checks the operating states of paths included in a protection group in real time, wherein the protection group includes a plurality of connection paths and a plurality of protection paths in a packet transport network, and the protection paths are alternate paths that can substitute for the connection paths when failure has occurred in the connection paths, and then the protection switching apparatus collects path state information according to the checked results, and stores the path state information in a protection group table storage (300). Here, the path state information includes identification information of each path, identification information of a protection group (or a multiple protection group) in which the path is included, and information about whether the path is in a normal state or in a failure state. Also, the path state information includes information about protection paths that can substitute for paths in which failure has occurred.

After the path state information is updated and stored in the protection group table storage, the protection switching apparatus checks whether there is a path in which failure has occurred upon packet transmission/reception, with reference to the path state information (310). If there is a path in which failure has occurred, the protection switching apparatus checks whether the path in which failure has occurred belongs to a multiple protection group, based on from identification information included in path state information of the path in which failure has occurred (320).

If the path in which failure has occurred belongs to no multiple protection group, the protection switching apparatus performs protection switching to a protection path that can substitute for the path in which failure has occurred, based on path state information of the path in which failure has occurred (330). Meanwhile, if the path in which failure has occurred belongs to a multiple protection group, the protection switching apparatus checks a protection switching history of paths included in the multiple protection group in a predetermined time period to determine whether the multiple protection group has ever been protection-switched in a predetermined time period (340). That is, connection paths included in a multiple protection group have the same source and destination. Accordingly, when failure occurs in one of connection paths included in a multiple protection group, the remaining connection paths included in the multiple protection group are also subject to failure at time intervals. Therefore, when it is checked that failure has occurred in one of paths included in a multiple protection group, the protection switching apparatus checks whether the multiple protection group has ever been protection-switched in a predetermined time period. If it is checked that the multiple protection group has ever been protection-switched in the predetermined time period, the protection switching apparatus terminates the protection-switching of the corresponding multiple protection group. Meanwhile, if it is checked that the multiple protection group has never been protection switched in the predetermined time period, the protection switching apparatus protection-switches the path in which failure has occurred and paths having the same source and destination as those of the path in which failure has occurred, which are included in the multiple protection group, to paths that can substitute for the paths, at the same time (350). When failure occurs in one of paths included in the multiple protection group, the corresponding path and paths having the same source and destination as those of the path are protection switched to paths that can substrate for the paths, thereby ensuring quick protection switching.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A protection switching apparatus for protection switching of a multiple protection group in a packet transport network, comprising:
a path management unit to establish a plurality of connection paths for transmitting/receiving packets, and a plurality of protection paths that are able to substitute for the plurality of connection paths, respectively, and to create a protection group including the connection paths and the protection paths;
a protection group controller to determine whether failure has occurred on the connection paths, based on path state information for each path included in the protection group, the path state information stored in the protection group table storage, and to issue an instruction for protection switching, according to the result of the determination; and
a protection switching unit to perform protection switching of a path in which failure has occurred to a protection path corresponding to the path in which failure has occurred, according to the instruction for protection switching, thus transmitting/receiving the packets to/from a switched protection path.

2. The protection switching apparatus of claim 1, wherein the path management unit comprises:
a group creator to establish the protection paths that are able to substitute for the connection paths in correspondence to the connection paths, and to create the protection group including the connection paths and the protection paths;
a multiple protection group creator to create the multiple protection group including the connection paths and the protection paths, wherein the connection paths are paths having the same source and destination among the connection paths included in the protection group, and the protection paths are able to substitute for the connection paths having the same source and destination in correspondence to the connection paths;
an identification information creator to create identification information of the protection group, identification information of the connection paths included in the protection group, and identification information of the multiple protection group,
wherein the protection group table storage stores the individual pieces of identification information created by the identification information creator, and path state information including the individual pieces of identification information.

3. The protection switching apparatus of claim 2, further comprising:
a path state management unit to determine whether or not failure has occurred on the paths included in the protection group and/or check operating states of the paths, thus updating path state information of the protection group stored in the protection group table storage.

4. The protection switching apparatus of claim 3, wherein the protection group controller comprises:
a failure path checking unit to check whether failure has occurred on any one of the paths included in the protection group, according to the path state information updated by the path state management unit, and to inform, when failure has occurred on any one of the paths, the path state management unit of the fact that failure has occurred on the path in which failure has occurred, in order to update the path state information;
a multiple protection group checking unit to check, when the path in which failure has occurred is protection switched to a protection path corresponding to the path in which failure has occurred, whether the path in which failure has occurred includes the identification information of the multiple protection group, based on path state information of the path in which failure has occurred; and
a protection switching processor to instruct the protection switching unit to perform protection switching of the path in which failure has occurred or the multiple protection group, according to the result of the checking by the multiple protection group checking unit.

5. The protection switching apparatus of claim 4, wherein the protection switching unit performs protection switching to a protection path corresponding to the path in which failure has occurred, according to an instruction for protection switching of the path in which failure has occurred.

6. The protection switching apparatus of claim 4, wherein the protection switching unit determines whether the path in which failure has occurred is included in the multiple protection group, according to an instruction for protection switching of the multiple protection group, and protection-switches, if the path in which failure has occurred is included in the multiple protection group, the path in which failure has occurred and paths having the same source and destination as those of the path in which failure has occurred, to protection paths that are able to substitute for the path in which failure has occurred and the paths having the same source and destination.

7. The protection switching apparatus of claim 4, wherein when the same multiple protection group as a multiple protection group first checked by the multiple protection group checking unit is checked in a predetermined time period, the protection switching processor instructs the protection switching unit not to perform protection switching of the same multiple protection group.

8. A method in which a protection switching apparatus performs protection switching of a protection group including a plurality of connection paths and a plurality of protection paths that are able to substitute for the connection paths in correspondence to the connection path, the method comprising:
checking operating states of the connection paths and the protection paths, which are included in the protection group, and storing path state information according to the operating states in a protection group table storage;
detecting whether there is a path in which failure has occurred, based on the path state information;
checking, if there is a path in which failure has occurred, whether the path in which failure has occurred is included in a multiple protection group, and protection-switching the path in which failure has occurred to a protection path that is able to substitute for the path in which failure has occurred;

9. The method of claim 8, wherein the protection group table storage stores identification information of the protection group, identification information of the connection paths and the protection paths, identification information of the multiple protection group, and path state information including the identification information of the protection group, the identification information of the connection paths and the protection paths, and the identification information of the multiple protection group, and
the multiple protection group includes a plurality of connection paths and a plurality of protection paths, wherein the connection paths are connection paths having the same source and destination among the connection paths included in the protection group, and the protection paths are paths that are able to substitute for the connection paths having the same source and destination in correspondence to the connection paths.

10. The method of claim 9, wherein the protection-switching of the path in which failure has occurred to the protection path comprises,
checking whether the path in which failure has occurred is included in the multiple protection group by determining whether the identification information of the multiple protection group is included in the path state information of the path in which failure has occurred; and
protection-switching, if the path in which failure has occurred is included in the multiple protection group, the path in which failure has occurred to a protection path that is able to substitute for the path in which failure has occurred.

11. The method of claim 10, wherein the protection-switching of the path in which failure has occurred to the protection path, comprises:
checking, if the path in which failure has occurred is included in the multiple protection group, a protection switching history of paths included in the multiple protection group, during a predetermined time period; and
determining whether paths having the same source and destination as those of the path in which failure has occurred have to be protection-switched to protection paths that are able to substitute for the paths having the same source and destination, according to the protection switching history.
